(19) United States
(12) Patent Application Publication
(10) Pub. No.: US 2017/0346203 A1
(43) Pub. Date: Nov. 30, 2017

(54) BOARD TERMINAL

(71) Applicant: SUMITOMO WIRING SYSTEMS, LTD., Yokkaichi (JP)

(72) Inventor: Hideki GOTO, Yokkaichi (JP)

(73) Assignee: SUMITOMO WIRING SYSTEMS, LTD., Yokkaichi (JP)

(21) Appl. No.: 15/605,556

(22) Filed: May 25, 2017

(30) Foreign Application Priority Data
May 30, 2016 (JP) 2016-107851

(51) Int. Cl. H01R 12/58; H01R 13/03

(52) U.S. Cl. CPC H01R 12/585; H01R 13/03

(57) ABSTRACT

A board terminal includes a metal wire material with a first end and a second end, the metal wire material including: a middle part that is between the first end and the second end, a connecting part that is at the first end and that is configured to be connected to a mating member, and a conductive part that is at the second end and that is configured to be inserted through a through-hole of a printed circuit board and is made to be conductive with an electrically conductive path, wherein: a first side edge of the connecting part is cut away from the first end toward the middle part for a specified length between the first end and the second end, and a width of the connecting part is narrower than the middle part, and a pressing part is formed by a step surface that is between the connecting part and the middle part.

### BACKGROUND

This disclosure relates to a board terminal that (i) is conductively connected to an electrically conductive path of a printed circuit board by being inserted through a through-hole of the printed circuit board and (ii) is formed of a metal wire material.

Conventionally, a board terminal is used to electrically connect an external electrically conductive path to an electrically conductive path of a printed circuit board used for a wiring system of a vehicle. Such a board terminal is generally formed such that one end is a connecting part that connects to a mating member, and the other end is a conductive part that is inserted through a through-hole of a printed circuit board and is made to be conductive with an electrically conductive path.

Recently, as vehicles are made to be smaller and the number of on-board electric components increases, higher density of mounting and wiring on a printed circuit board is demanded. In a board terminal as well, usage of a smaller board terminal has been considered so as to handle such wiring with higher density.

Thus, Japanese Published Patent Application 2000-30834 proposes to provide a small board terminal with a good yield, using a metal wire material. The metal wire material is a material that linearly extends in a rectangular cross-sectional shape, in which one side is approximately 0.64 mm. Merely by cutting the metal wire material to a specified length, a board terminal can be easily manufactured, having (i) desired size of a connecting part and (ii) a good yield.

### SUMMARY

However, if a board terminal is formed by cutting a metal wire material to a specified length, although a connecting part or a conductive part having a narrow width and a good yield can be provided, it is difficult to arrange a protruding part at a middle part in a length direction of the board terminal. Thus, if the board terminal is insertingly arranged in a through-hole of the printed circuit board, it was necessary to press-fit or insert a tip end of the connecting part through the through-hole by pushing the tip end of the connecting part. As a result, there was an inherent problem that the tip end of the connecting part, which is the furthest from the conductive part of the board terminal, is pushed, a large bending moment is generated by slight inclination or the like of the board terminal, and a problem easily occurs in which the board terminal is bent when the conductive part is inserted through the through-hole. In particular, to handle recent increases in density, as the size (cross section) of the connecting part becomes smaller, such a problem becomes more apparent, so some type of countermeasure was demanded.

An exemplary aspect of the present disclosure provides a board terminal with a new structure, which is formed by cutting a metal wire material to a specified length, and which can be stably pushed when the board terminal is inserted through a through-hole even when a width of the connecting part is narrow.

According to an exemplary aspect of the disclosure, a board terminal includes a metal wire material with a first end and a second end, the metal wire material including: a middle part that is between the first end and the second end, a connecting part that is at the first end and that is configured to be connected to a mating member, and a conductive part that is at the second end and that is configured to be inserted through a through-hole of a printed circuit board and is made to be conductive with an electrically conductive path, wherein: a first side edge of the connecting part is cut away from the first end toward the middle part for a specified length between the first end and the second end, and a width of the connecting part is narrower than the middle part, and a pressing part is formed by a step surface that is between the connecting part and the middle part.

According to this exemplary aspect, the first side edge is cut away from the connecting part from a tip end toward the middle part for a specified length, and the width of the connecting part is narrower than that of the middle part of the board terminal. Furthermore, the step surface formed between the middle part and the connecting part can be used as a pressing part. Thus, while the width dimension of the connecting part can be made narrower, the conductive part can be stably insertingly arranged through the through-hole of the printed circuit hoard by pressing the pressing part. Because of this, compared to a case in which the tip end of the connecting part is pressed and the board terminal is insertingly arranged through the through-hole, as with a conventional board terminal formed of a metal wire material, even when the width dimension of the connecting part is thin, and the size is small, the problem of deformation of the connecting parts can be alleviated or eliminated, and the board terminal can be stably insertingly arranged on the printed circuit board side.

Furthermore, only one side edge of the connecting part is cut away, so compared to a conventional board terminal, in which a metal plate material is press-punched and in which both side edges are cut away and pressing parts are arranged to protrude at both sides of the connecting part, the board terminals can be formed with a good yield, and the connecting parts can he aligned at a more narrow interval. Because of this, this can also advantageously handle demands for miniaturization of connectors with increased density.

Additionally, by changing the cutting width at which the one side edges of the connecting parts are cut, the board terminals can also be formed with connecting parts with various sizes and in which a mold is commonly used for metal wire materials using the same specifications. Thus, component maintenance and operation efficiency can also be advantageously improved.

According to an exemplary aspect of the disclosure, a plating layer formed of conductive metal is provided on a surface of the metal wire material, wherein: the metal wire material is provided with the first side edge and a second side edge that are opposite to each other in a direction perpendicular to a length direction; the second side edge is cut away from the conductive part from the second end toward the middle part for a specified length, and the conductive part is provided with a soldering part having a width narrower than that of the middle part, and a board abutment part is formed by a step surface formed between the conductive part and the middle part.

According to this exemplary aspect, at the connecting part and the conductive part of the board terminal, the first side edge and the second side edge that are opposite to each other in a direction perpendicular to the axial direction are respectively cut away. The connecting part and the conductive part are protrudingly arranged respectively on both sides, in the length direction, of the terminal, with the middle part sandwiched therebetween, at positions that are opposite each other in a direction perpendicular to the axial direction, and the pressing part and the board abutment part are also provided. Thus, the soldering part of the conductive part can be arranged directly under the pressing part, and a pressing balance when the board terminals are pressed can be suitably ensured.

In addition, a plating layer formed of conductive metal is provided on the surface of the metal wire material. Thus, even if the soldering part is arranged by cutting away the one side edge of the conductive part that is inserted through the through-hole, the plating layer still remains on other surfaces of the conductive part. Thus, plating is not needed later, and soldering can be suitably realized.

Furthermore, the soldering part is formed by cutting away the one side edge of the conductive part so as to make the width narrower. Thus, this can also advantageously handle mounting of the board terminal on the printed circuit board, and wiring with increased density. Additionally, uprightness of the board terminal on the printed circuit board is stably maintained by the board abutment part that is formed simultaneously.

According to an exemplary aspect of the disclosure, the conductive part is provided with a pressure contact part that is configured to be press-fitted into the through-hole of the printed circuit board and connected by pressure contact to the electrically conductive path of the printed circuit board.

According to this exemplary aspect, at the other end in the length direction, the pressure contact part is arranged that is made to be electrically conductive with the conductor at the inner surface of the through-hole that is conductive with the electrically conductive path on the printed circuit board. Thus, there is no need for soldering, so the manufacturing cost can be reduced.

Furthermore, the pressing part that is needed when the board terminal is provided with a pressure contact part to the through-hole can be simultaneously formed, with a sufficient area, using a structure in which. the width of the connecting part is made narrower by merely cutting away the one side edge of the connecting part. Thus, the pressing part, which was difficult to form in board terminals having a conventional structure using a metal wire material, can also advantageously be ensured, and a board terminal having a press fitting type conductive part can also be advantageously provided by using a metal wire material.

According to an exemplary aspect of the disclosure, the metal wire material has a rectangular cross section.

According to this exemplary aspect, the metal wire material has a rectangular cross section, so the pressing part and the board abutment part can also be made to have a rectangular cross section, so they can be constituted with cross-sectional areas of sufficient width. Thus, workability when the pressing part is pressed can be obtained, and strength of the board abutment part can be advantageously ensured.

According to this disclosure, a first side edge is cut away from the connecting part from a tip end toward the middle part for a specified length, and the width of the connecting part is narrower than that of the middle part of the board terminal. Furthermore, the step surface formed between the middle part and the connecting part can be used as a pressing part. Thus, while the width dimension of the connecting part can be made narrower, the conductive part can be stably insertingly arranged through the through-hole of the printed circuit board by pressing the pressing part. Because of this, compared to a conventional board terminal formed of a metal wire material, even when the width dimension of each of the connecting part is thin, and the size is small, the problem of deformation of the connecting part can be alleviated or eliminated, and the board terminal can be stably arranged on the printed circuit board side. Furthermore, only the one side edge of the connecting part is cut away, so compared to a conventional board terminal in which both side edges are cut away and pressing parts are arranged to protrude at both sides of the connecting parts, the board terminal can be formed with a good yield, and the connecting parts can be aligned at a more narrow interval. Because of this, this can also advantageously handle demands for miniaturization of connectors with increased density. Additionally, by changing the cutting width at which the one side edges of the connecting parts are cut, the board terminals can also be formed with connecting parts with various sizes and in which a mold is commonly used for metal wire materials using the same specifications. Thus, component maintenance and operation efficiency can also be advantageously improved.

### BRIEF DESCRIPTION OF THE DRAWINGS

Various exemplary aspects of the disclosure will be described with reference to the drawings, wherein:

FIG. 1 is a perspective view showing a board terminal of a first exemplary aspect of this disclosure.

FIG. 2 is a right side view of FIG. 1.

FIG. 3 is a perspective view showing a state in which board terminals of this exemplary aspect are arranged on a printed circuit board.

FIG. 4 is a right side view of FIG. 3.

FIG. 5 is a perspective view showing a board terminal of a second exemplary aspect of this disclosure.

FIG. 6 is a perspective view showing a state in which board terminals of this exemplary aspect are arranged on a printed circuit board.

### DETAILED DESCRIPTION OF EMBODIMENTS

Hereafter, exemplary aspects of the disclosure are explained with reference to the drawings.

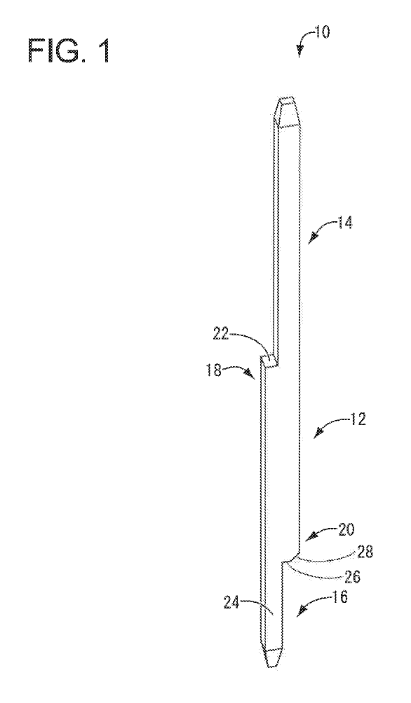

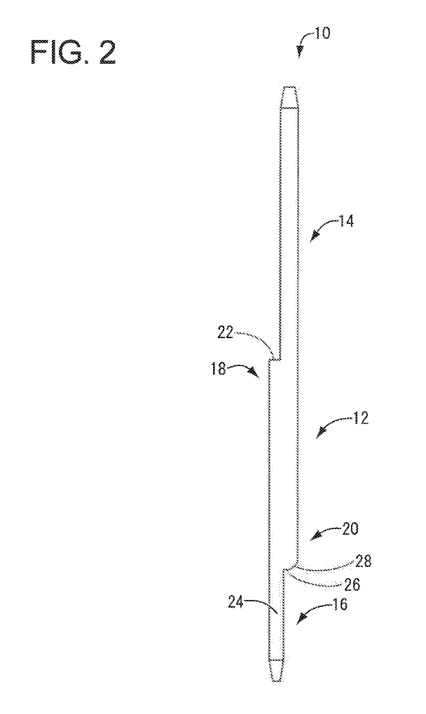

First, FIGS. 1-2 show a board terminal 10 of a first exemplary aspect of this disclosure. The board terminal 10 is formed by cutting a rectangular metal wire material, having a rectangular cross-sectional shape, to a specified length. At a middle part of the board terminal 10 in a length direction (up/down directions of FIGS. 1 and 2), a middle part 12 is formed which extends having a substantially constant rectangular cross-sectional shape of the rectangular metal wire material as-is. Additionally, at one end (upper end of FIGS. 1 and 2), a connecting part 14 is formed that is connected to an undepicted mating member, and at the other end (lower end of FIGS. 1 and 2), a conductive part 16 is formed which is connected to a later-mentioned printed circuit board 30, and the middle part 12 is between the connecting part 14 and the conductive part 16. Furthermore, in the following explanation, an “upper part” refers to an upper part of FIGS. 1 and 2, a “lower part” refers to a lower part of FIGS. 1 and 2, a “front part” refers to a left part of FIG. 2, and a “rear part” refers to a right part of FIG. 2. Additionally, a “length direction” refers to up/down directions of FIGS. 1 and 2, and a “plate width direction” refers to right/left directions of FIGS 2.

A rectangular metal wire material that forms the hoard terminal 10 is a wire material that is formed of copper alloy or the like and extends in a substantially constant rectangular cross-sectional shape. Furthermore, an undepicted plating layer is provided over the entire surface on a circumference of the rectangular metal wire material. Such a plating layer is formed such that tin or the like is layered and plated on an underlayer plating such as copper, nickel, or the like. In addition, the rectangular metal wire material is provided with a first side edge 18 and a second side edge 20 that are opposite to each other in a direction perpendicular to the axial direction, that is, in a plate width direction (right/left direction in FIG. 2).

As shown in FIGS. 1 and 2, a connecting part 14 of the board terminal 10 is formed to be narrower than the middle part 12 by cutting away the first side edge 18, which corresponds to one side edge, by a substantially constant width from a tip end (upper end of FIGS. 1 and 2) toward the middle part 12 for a specified length. Thus, a step surface that has a substantially rectangular shape in a plan view and extends in a direction perpendicular to the axial direction is formed between the connecting part 14 and the middle part 12, and such a step surface creates a pressing part 22. Meanwhile, the conductive part 16 of the board terminal 10 is provided with a soldering part 24 formed so as to have a narrower width than that of the middle part 12 by cutting away the second side edge 20 by a substantially constant width from a tip end (lower end of FIGS. 1 and 2) toward the middle part 12 for a specified length. Thus, a step surface that has a substantially rectangular shape in a plan view and extends in a direction perpendicular to the axial direction is formed between the conductive part 16 and the middle part 12, and such a step surface creates a board abutment part 26. Furthermore, at an end of the second side edge 20 at the board abutment part 26, a tapered surface 28 is formed which extends in a diagonally upward direction. In addition, both end edges of the board terminal 10 in the length direction are given a tapered shape by crushing processing or the like. Additionally, the cutting-away steps for the connecting part 14 and the conductive part 16 of the board terminal 10 are performed by cutting processing, press-punching processing, or the like.

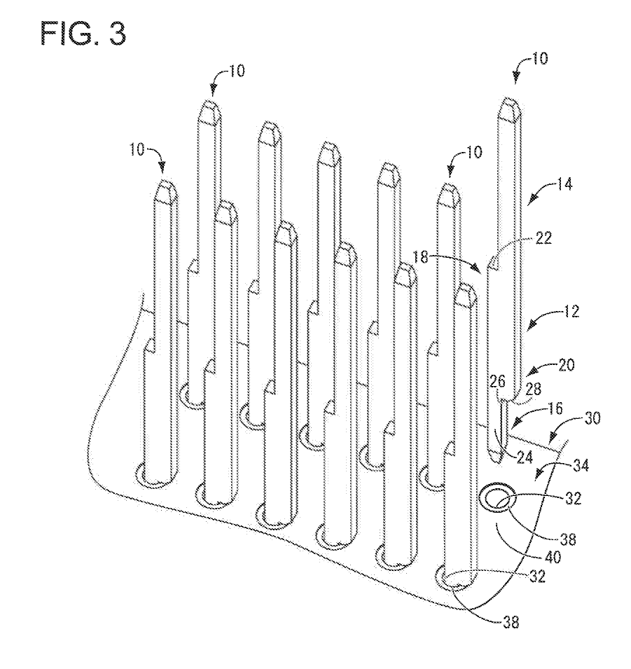

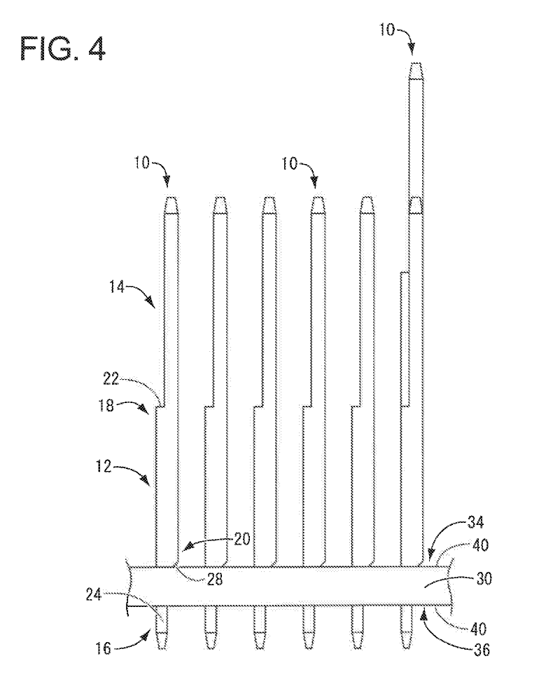

As shown in FIGS. 3 and 4, for example, the soldering parts 24 of the conductive parts 16 of the board terminals 10 having the above-described structure are inserted through through-holes 32 that are arranged through the printed circuit board 30, and soldered. Thus, the board terminals 10 are electrically connected to undepicted printed wiring or the like, which is an electrically conductive path formed on the printed circuit board 30. More specifically, undepicted plating layers are provided over the entire inner circumferential surfaces of the through-holes 32. At a front surface 34 side and a rear surface 36 side of the printed circuit board 30, land parts 38 are arranged that are connected to the plating layers at the periphery of openings of the through-holes 32. Thus, the board terminals 10 inserted through the through-holes 32 and soldered are conductively connected to the printed wiring or the like via solder, the plating layers, and the land parts 38. As a result, the connecting parts 14 stand on the printed circuit board 30 and can be connected to mating connectors or the like as undepicted external terminals. Additionally, at a region excluding the through-holes 32 and the land parts 38 of the front surface 34 and the rear surface 36 of the printed circuit board 30, resist layers 40 formed of a known resist are layered so as to protect the front surface 34 and the rear surface 36 as well as the printed wiring. Here, at the board abutment parts 26 that contact the front surface 34 of the printed circuit board 30 when the conductive parts 16 of the board terminals 10 are inserted through the through-holes 32 that are arranged through the printed circuit board 30, tapered surfaces 28 are formed which extend in a diagonally upward direction to the ends of the second side edges 20. Thus, the board abutment parts 26 are advantageously suppressed from riding up on the resist layer 40 arranged at the periphery of the land parts 38 of the through-holes 32, and the board terminal 10 stably stands on the printed circuit board 30.

According to the thus-constituted board terminal 10, by cutting away the first side edge 18 of the connecting part 14 by a substantially constant width from the tip end toward the middle part 12 for a specified length, the width of the connecting part 14 is formed to be narrower than that of the middle part 12, and the pressing part 22 is constituted by a step surface that extends between the connecting part 14 and the middle part 12 in a direction perpendicular to the axial direction. Thus, while reducing the width dimension of the connecting part 14, the pressing part 22 can be pressed, and the conductive part 16 can be stably insertingly arranged through the through-hole 32 of the printed circuit board 30. Thus, compared to a case in which the tip end of the connecting part 14 is pressed and the board terminal is insertingly arranged through the through-hole 32, as with a conventional board terminal formed of a metal wire material, a pressing force is not applied to the connecting part 14. Therefore, even when the width dimension of each of the connecting parts 14 is thin, and the size is small, the problem of deformation of the connecting parts 14 can be alleviated or eliminated, and the board terminals 10 can be stably insertingly arranged through the through-holes 32 of the printed circuit board 30. Furthermore, only the first side edges 18 of the connecting parts 14 are cut away, so compared to a conventional case in which both side edges are cut away and the pressing parts 22 are arranged to protrude at both sides of the connecting parts 14, the board terminals 10 can be formed with a good yield, and the board terminals 10 can be aligned at a more narrow interval on the printed circuit board 30. Because of this, this can also advantageously handle demands for miniaturization of mating connectors connected to the connecting parts 14, and for mating connectors with increased density. Additionally, by changing the cutting widths at which the first side edges 18 of the connecting parts 14 are cut, the board terminals 10 can also be formed with connecting parts 14 with various sizes and in which a mold is commonly used for metal wire materials using the same specifications. Thus, component maintenance and operation efficiency can also be advantageously improved.

Additionally, at the connecting parts 14 and the conductive parts 16 of the board terminals 10, the first side edges 18 and the second side edges 20 facing each other in a direction perpendicular to the axial direction are respectively cut away. Thus, the connecting parts 14 and the conductive parts 16 are protrudingly arranged respectively on both sides, in the length direction, of the terminals 10, with the middle parts 12 sandwiched therebetween, at positions that are opposite each other in a direction perpendicular to the axial direction, and the pressing parts 22 and the board abutment parts 26 are also provided. Thus, the soldering parts 24 of the conductive parts 16 that are inserted through the through-holes 32 of the printed circuit board 30 and soldered can be arranged directly under the pressing parts 22, and the board terminals 10 can be effectively pressed and insertingly arranged through the through-holes 32 of the printed circuit board 30. Furthermore, the metal wire material has a rectangular cross section, so the pressing parts 22 and the board abutment parts 26 can also be made to have a rectangular cross section and can be constituted with cross-sectional areas of sufficient width. Thus, when the pressing parts 22 are pressed, workability can be made suitable, and strength of the board abutment parts 26 can be advantageously maintained. In addition, a plating layer formed of conductive metal is provided on the surface of the metal wire material. Thus, even if the soldering parts 24 are arranged by cutting away the second side edges 20 of the conductive parts 16 that are inserted through the through-holes 32 and soldered, the plating layers still remain on other surfaces of the conductive parts 16. Thus, plating is not needed later, and soldering can be suitably realized. Furthermore, the soldering parts 24 are formed by cutting away the second side edges 20 of the conductive parts 16 so as to make the widths narrower. Thus, this can also advantageously handle mounting of the board terminals 10 on the printed circuit board 30 via the through-holes 32, and printed wiring with increased density. Additionally, uprightness of the board terminals 10 on the printed circuit board 30 is stably maintained.

Exemplary aspects of the disclosure are described in detail above, but this disclosure is not limited to these specific descriptions. For example, the cross-sectional shape of the metal wire material is not limited to a rectangular cross section. Upon considering rigidity of the board terminals 10, board space, and the like that are demanded, an arbitrary shape, such as a round shape or an elliptical shape, can be adopted. Even in that case, at the connecting parts 14 and the conductive parts 16 of the board terminals 10, the first side edges 18 and the second side edges 20 that face each other in a direction perpendicular to the axial direction are respectively cut away; thus, the connecting parts 14 and the conductive parts 16 are protrudingly arranged at respective positions that are opposite to each other in a direction perpendicular to the axial direction, and the pressing parts 22 and the board abutment parts 26 are arranged. Therefore, it is clear that operation effects of this disclosure can be seen in the same manner.

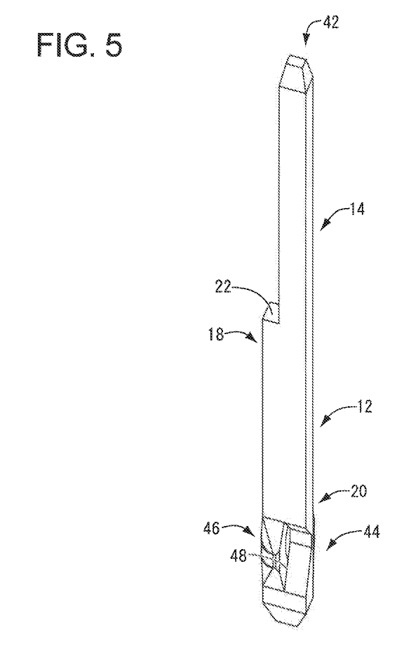

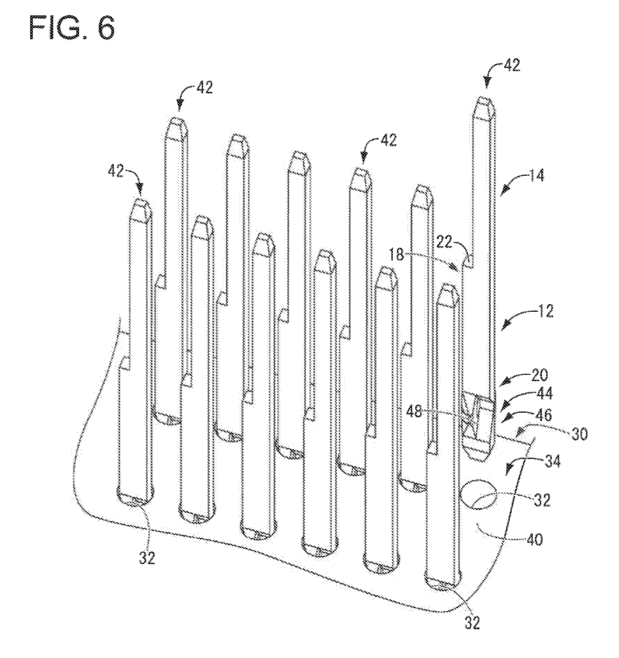

Additionally, in the above-mentioned first exemplary aspect, the soldering parts 24 of the conductive parts 16 are inserted through the through-holes 32 arranged in the printed circuit board 30 and soldered; thus, they are electrically connected to undepicted printed wiring or the like that is an electrically conductive path formed on the printed circuit board 30. However, for example, as shown by board terminals 42 of the second exemplary aspect of FIGS. 5 and 6, the conductive parts 44 can be provided with pressure contact parts 46 that press-fit to the through-holes 32 of the printed circuit board 30 and connected by pressure contact to the plating layers on the inner surfaces of the through-holes 32 that are electrically conductive with the printed wiring that is an electrically conductive path of the printed board 30. More specifically, the board terminals 42 are formed by, for example, cutting, to a specified length, a. metal wire material formed of copper alloy, such as phosphor bronze and C194, provided with rigidity to a degree in which a spring property can apply by shape processing. At the middle parts of the pressure fitting parts 46 in a plate width direction, slits 48 are arranged that extend in a length direction of the pressure fitting parts 46, and the pressure fitting parts 46 are constituted by a so-called action pin shape, which causes both side portions of the slits 48 to protrude at sides opposite to each other. Thus, in the board terminals 42 of this exemplary aspect, there is no need for soldering, so the manufacturing cost can be reduced. Furthermore, the pressing parts 22 that are needed when the board terminals 42 are press-fit to the through-holes 32 can be easily formed with sufficient areas, using a structure in which the first side edges 18 of the connecting parts 14 are merely cut away. Thus, the pressing parts 22 can also easily be formed, which were difficult to form in board terminals having a conventional structure using a metal wire material, and the board terminals 42 having the conductive parts 44 with the press fitting parts 46 can also be advantageously provided by using a metal wire material.

Additionally, in the above-mentioned exemplary aspect, plating layers formed of conductive metal are provided on the surfaces of the metal wire material, but this is not needed. For example, a plating layer can be arranged by post plating.

What is claimed is:

1. A board terminal comprising:
a metal wire material with a first end and a second end, the metal wire material including:
a middle part that is between the first end and the second end,
a connecting part that is at the first end and that is configured to be connected to a mating member, and
a conductive part that is at the second end and that is configured to be inserted through a through-hole of a printed circuit board and is made to be conductive with an electrically conductive path, wherein:
a first side edge of the connecting part is cut away from the first end toward the middle part for a specified length between the first end and the second end, and a width of the connecting part is narrower than the middle part, and
a pressing part is formed by a step surface that is between the connecting part and the middle part.

2. The board terminal as set forth in claim 1, further comprising:
a plating layer formed of conductive metal that is provided on a surface of the metal wire material, wherein:
the metal wire material is provided with the first side edge and a second side edge that are opposite to each other in a direction perpendicular to a length direction;
the second side edge is cut away from the conductive part from the second end toward the middle part for a specified length, and the conductive part is provided with a soldering part having a width narrower than that of the middle part, and
a board abutment part is formed by a step surface formed between the conductive part and the middle part.

3. The board terminal as set forth in claim 1, wherein:
the conductive part is provided with a pressure contact part that is configured to be press-fitted into the through-hole of the printed circuit board and connected by pressure contact to the electrically conductive path of the printed circuit board.

4. The board terminal as set forth in claim 1, wherein:
the metal wire material has a rectangular cross section.

5. The board terminal as set forth in claim 2, wherein:
the metal wire material has a rectangular cross section.

6. The board terminal as set forth in claim 3, wherein:
the metal wire material has a rectangular cross section.
